(19) United States
(12) Patent Application Publication
(10) Pub. No.: US 2009/0158599 A1
(43) Pub. Date: Jun. 25, 2009

(54) ADHESIVE TAPE CUTTING DEVICE

(76) Inventor: Brian Wu, Chiayi Hsien (TW)

Correspondence Address: LADAS & PARRY, 5670 WILSHIRE BOULEVARD, SUITE 2100, LOS ANGELES, CA, 90036-5679, US

(21) Appl. No.: 11/960,536

(22) Filed: Dec. 19, 2007

(51) Int. Cl. B26B 27/00

(52) U.S. Cl. 30/296.1

(57) ABSTRACT

An adhesive tape cutting device includes: a sleeve body sleeved on an adhesive tape roll and having a top wall defining a tape slot, the tape slot being defined by a slot-defining wall having opposite front and rear edges, the top wall having front and rear end portions and a protruded portion disposed between and protruding outwardly from the front end portion and the slot-defining wall, the rear end portion and the protruded portion being separated by the tape slot, the protruded portion extending outwardly and radially through a tangent line from one side of the tangent line to the other side of the tangent line; and a cutting member mounted on the front end portion of the top wall of the sleeve body.

### BACKGROUND OF THE INVENTION

1. Field of the Invention

The invention relates to an adhesive tape cutting device, more particularly to an adhesive tape cutting device that has a top wall with a protruded portion extending through a tangent line passing through an edge of a slot-defining wall.

2. Description of the Related Art

Referring to FIGS. 1 and 2, a conventional adhesive tape cutting device 3 is shown to be mounted movably on an adhesive tape roll 4 for cutting an adhesive tape 41 thereof. The adhesive tape cutting device 3 includes a sleeve body 31 and a cutting member 32. The sleeve body 31 is adapted to be sleeved removably and movably on the adhesive tape roll 4, and has a pair of side walls 311 confining a groove therebetween to retain a segment of the adhesive tape roll 4 therein, a pair of bottom end walls 312 each extending transversely and inwardly from a bottom edge of a respective one of the side walls 311, and a top wall connected to top edges of the side walls 311, having a rear end portion 314 and a protruded portion 313, and defining a tape slot 315 for extension of an unrolled end of the adhesive tape 41 therethrough. The protruded portion 313 has a triangular planar rear surface 316 and a tip end 3131. The tape slot 315 is defined by a slot-defining wall having a rear edge 317. A tangent line 40 passing through the rear edge 317 of the slot-defining wall is defined, and is tangential relative to a center of the adhesive tape roll 4. The protruded portion 313 of the top wall is disposed at one side of the tangent line that is adjacent to the adhesive tape roll 4.

In use, the adhesive tape 41 is extended through the tape slot 315, is attached to the triangular planar rear surface 316, passes over the tip end 3131, and is further extended beyond an edge of the cutting member 32 for cutting a predetermined length of the unrolled end of the adhesive tape 41. However, since the unrolled end of the adhesive tape 41 is tensioned solely by the tip end 3131, and since only a portion of the unrolled end of the adhesive tape 41 is attached to the triangular planar rear surface 316, the tension of the unrolled end of the adhesive tape 41 is insufficient during a cutting operation, thereby resulting in an uneven edge of the cut piece of the adhesive tape 41. In addition, extension of the unrolled end of the adhesive tape 41 into and through the tape slot 315 is relatively inconvenient.

### SUMMARY OF THE INVENTION

Therefore, the object of the present invention is to provide an adhesive tape cutting device that can overcome the aforesaid drawbacks associated with the prior art.

Accordingly, an adhesive tape cutting device of this invention comprises: a sleeve body adapted to be sleeved on an adhesive tape roll and defining a channel for extension of the adhesive tape roll therethrough, the sleeve body having a top wall defining a tape slot in spatial communication with the channel for extension of an unrolled end portion of an adhesive tape of the adhesive tape roll therethrough, the tape slot being defined by a slot-defining wall having opposite front and rear edges, the top wall having front and rear end portions and a protruded portion disposed between and protruding outwardly from the front end portion and the slot-defining wall, the rear end portion and the protruded portion being separated by the tape slot, the protruded portion extending outwardly and radially through a tangent line, which is adapted to be tangential relative to a center of the adhesive tape roll and which passes through the rear edge of the slot-defining wall, from one side of the tangent line to the other side of the tangent line that is distal from the adhesive tape roll compared to said one side of the tangent line; and a cutting member mounted on the front end portion of the top wall of the sleeve body.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional adhesive tape cutting device used for an adhesive tape roll;

FIG. 2 is a partly sectional view of the conventional adhesive tape cutting device;

FIG. 3 is a perspective view of the first preferred embodiment of an adhesive tape cutting device according to the present invention used for an adhesive tape roll;

FIG. 4 is a partly sectional view of the first preferred embodiment;

FIGS. 5 and 6 are perspective views of the first preferred embodiment in a state of use;

FIG. 7 is a perspective view of the second preferred embodiment of the adhesive tape cutting device according to this invention in a state of use;

FIG. 8 is a partly sectional view of the second preferred embodiment;

FIG. 9 is an exploded perspective view of the third preferred embodiment of the adhesive tape cutting device according to the present invention;

FIG. 10 is a sectional view of the third preferred embodiment in a state of use;

FIG. 11 is an exploded perspective view of the fourth preferred embodiment of the adhesive tape cutting device according to the present invention;

FIG. 12 is a schematic side view of the fifth preferred embodiment of the adhesive tape cutting device according to this invention in a state of use; and

FIG. 13 is a schematic side view of the sixth preferred embodiment of the adhesive tape cutting device according to this invention in a state of use.

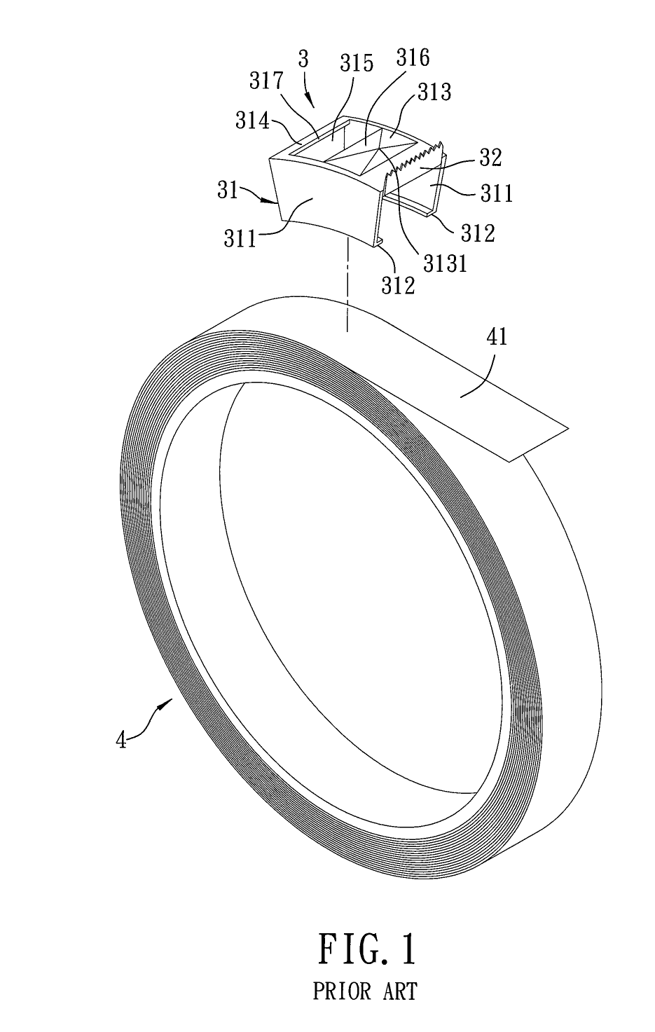

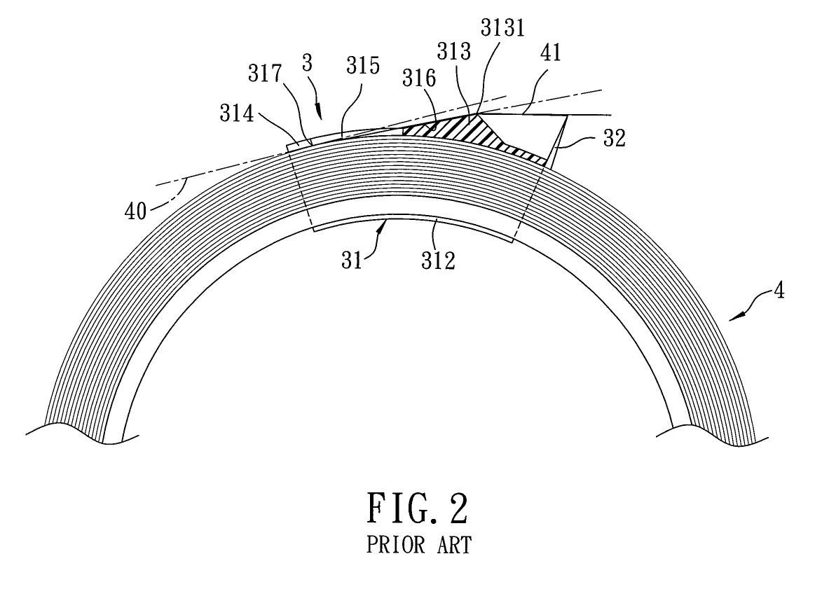

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

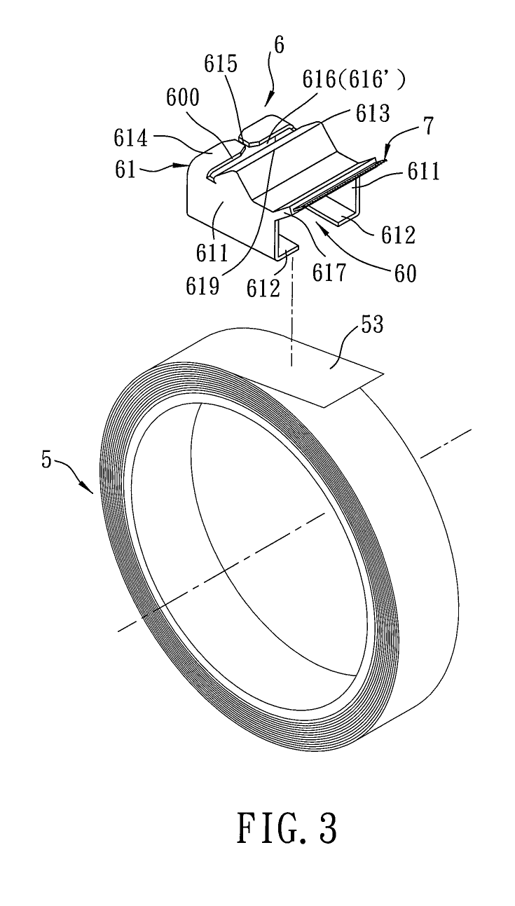

Referring to FIGS. 3 to 5, the first preferred embodiment of an adhesive tape cutting device according to the present invention is shown to include: a sleeve body 6 adapted to be sleeved on an adhesive tape roll 5 and defining a channel 60 for extension of the adhesive tape roll 5 therethrough, the sleeve body 6 having a top wall 61 defining a tape slot 616 in spatial communication with the channel 60 for extension of an unrolled end portion 531 of an adhesive tape 53 of the adhesive tape roll 5 therethrough, the tape slot 616 being defined by a slot-defining wall 616′ having opposite front and rear edges 601, 600, the top wall 61 having front and rear end portions 617, 614 and a protruded portion 613 disposed between and protruding outwardly from the front end portion 617 and the slot-defining wall 616′, the rear end portion 614 and the protruded portion 613 being separated by the tape slot 616, the protruded portion 613 extending outwardly and radially through a tangent line 50, which is adapted to be tangential relative to a center of the adhesive tape roll 5 and which passes through the rear edge 600 of the slot-defining wall 616′, from one side of the tangent line 50 to the other side of the tangent line 50 that is distal from the adhesive tape roll 5 compared to said one side of the tangent line 50; and a cutting member 7 mounted on the front end portion 617 of the top wall of the sleeve body 6. The sleeve body 6 is made from a plastic material, and is formed by injection molding techniques.

In this embodiment, the protruded portion 613 of the top wall 61 of the sleeve body 6 has a round top end 619 and a planar rear surface 610 extending rearwardly from the round top end 619 toward the front edge 601 of the slot-defining wall 616′. The planar rear surface 610 of the protruded portion 613 of the top wall 61 has a constant width (W), and extends along a line 691 that passes through the rear edge 600 of the slot-defining wall 616′ and that cooperates with the tangent line 50 to define an angle θ ranging from 25 to 75 degrees.

In this embodiment, the rear end portion 614 defines a tape slit 615 extending therethrough to divide the rear end portion 614 into two halves. The tape slit 615 is in spatial communication with the tape slot 616 for extension of the unrolled end portion 531 of the adhesive tape 53 of the adhesive tape roll 5 therethrough and into and through the tape slot 616.

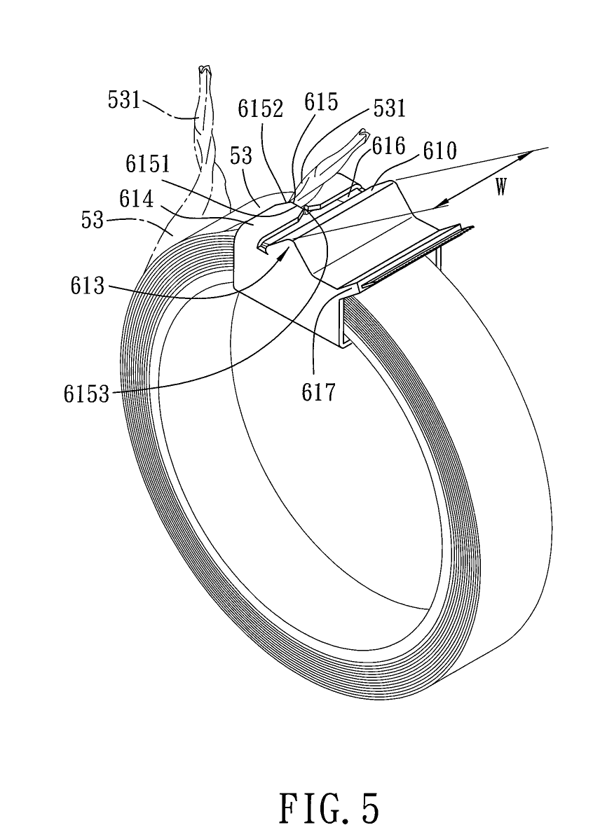

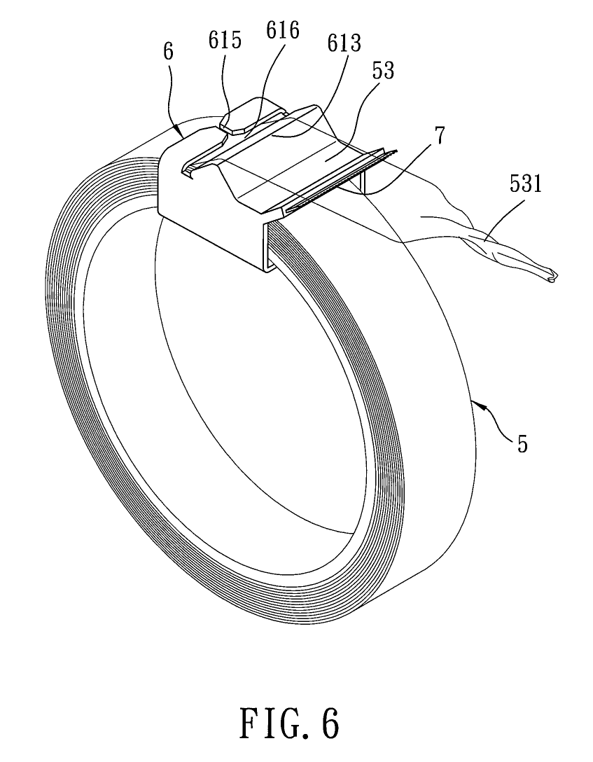

Referring to FIGS. 5 and 6, the tape slit 615 has a middle section 6151, a rear section 6152 diverging from the middle section 6151, and a front section 6153 opposite to the rear section 6152 and diverging from the middle section 6151. The tape slit 615 extends in a transverse direction relative to the tape slot 616. The rear section 6152 of the tape slit 615 facilitates extension of the unrolled end portion 531 of the adhesive tape 53 through the tape slit 615 and into and through the tape slot 616.

In this embodiment, the sleeve body 6 further has two opposite side walls 611 extending downwardly from two opposite sides of the top wall 61, and two opposite bottom walls 612 extending respectively from bottom ends of the side walls 611 toward each other to anchor on an inner wall of the adhesive tape roll 5.

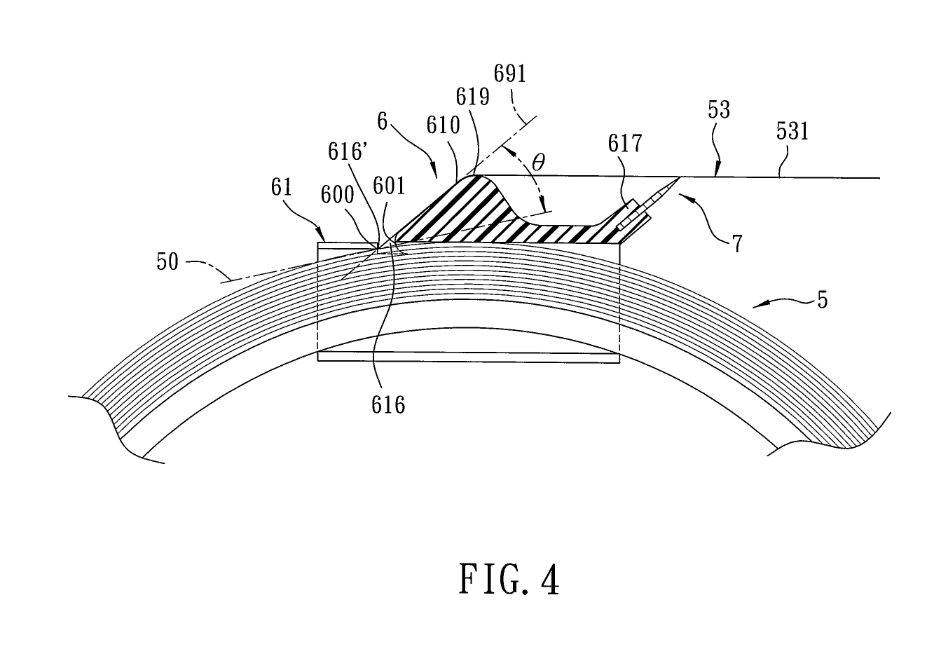

In use, referring back to FIG. 4, the unrolled end portion 531 of the adhesive tape 53 of the adhesive tape roll 5 is extended from the tape slot 616, abuts against the rear edge 600 of the slot-defining wall 616′, is attached to and covers substantially the planar rear surface 610 of the protruded portion 613 of the top wall 61, abuts against the round top end 619 of the protruded portion 613 of the top wall 61, and is further extended to rest on the cutting member 7. In this manner, since the unrolled end portion 531 of the adhesive tape 53 is brought into abutment against the rear edge 600 of the slot-defining wall 616′ and the round top end 619 of the protruded portion 613 of the top wall 61 and is attached to and covers substantially the planar rear surface 610 of the protruded portion 613 of the top wall 61, a sufficient tension formed in the unrolled end portion 531 of the adhesive tape 53 is achieved, thereby facilitating cutting of the unrolled end portion 531 of the adhesive tape 53 and achieving a smooth edge of the cut piece of the adhesive tape 53.

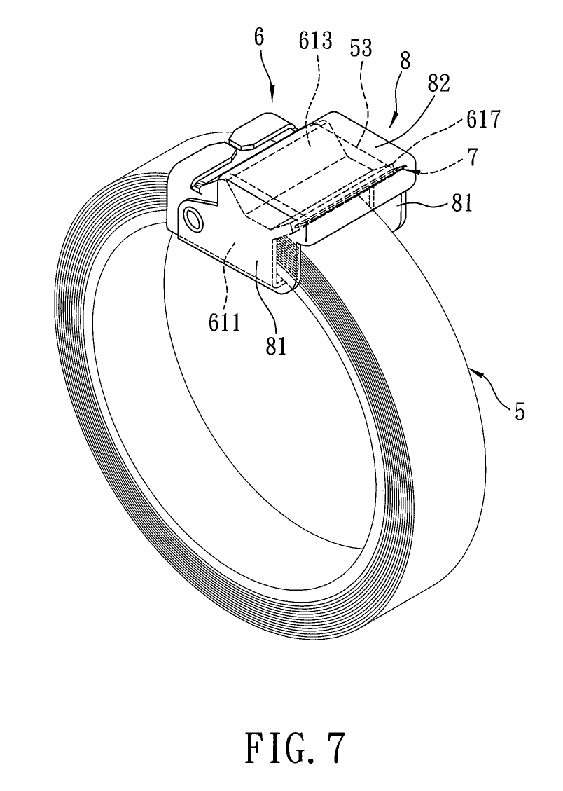

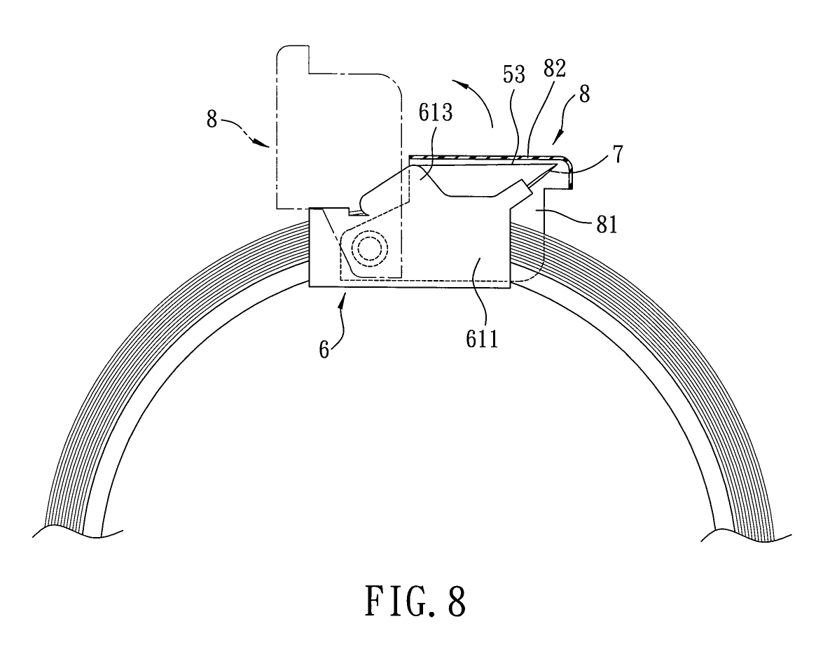

FIGS. 7 and 8 illustrate the second preferred embodiment of the adhesive tape cutting device according to this invention. The second preferred embodiment differs from the previous embodiment in that the adhesive tape cutting device further includes a cover 8 for covering the unrolled end portion 531 of the adhesive tape 53 and the cutting member 7. The cover 8 has two opposite side walls 81 respectively pivoted to the side walls 611 of the sleeve body 6, and a top wall 82 interconnecting the side walls 81 of the cover 8 for covering at least the protruded portion 613 and the front end portion 617 of the top wall 61 of the sleeve body 6. The cover 8 serves to shield the adhesive tape 53 and the adhesive tape cutting device from dust.

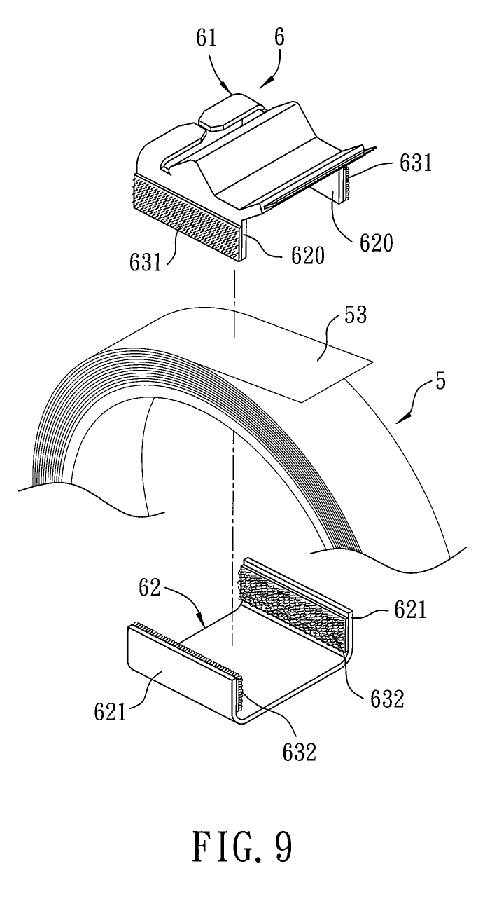

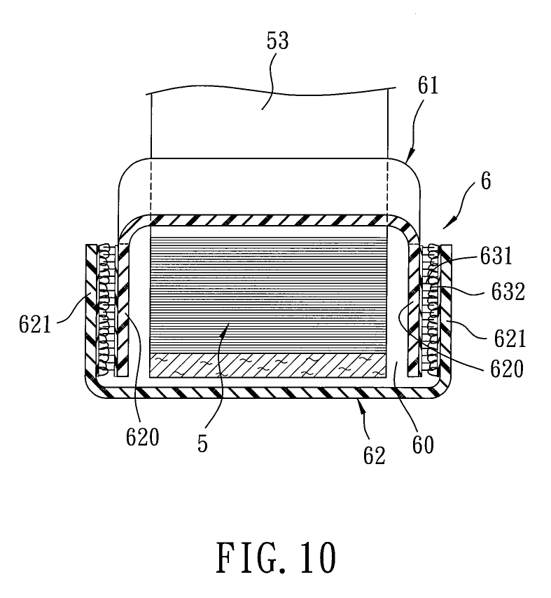

FIGS. 9 and 10 illustrate the third preferred embodiment of the adhesive tape cutting device according to this invention. The third preferred embodiment differs from the previous embodiments in that the sleeve body 6 further has a bottom wall 62 opposite to the top wall 61, and that each of the side walls 611 of the sleeve body 6 is divided into upper and lower side walls 620, 621. The upper side walls 620 extend downwardly and respectively from two opposite sides of the top wall 61. The lower side walls 621 extend upwardly and respectively from two opposite sides of the bottom wall 62, and are connected detachably and respectively to the upper side walls 620 so as to cooperate with the top and bottom walls 61, 62 and the upper side walls 620 to define the channel 60. In this embodiment, the upper and lower side walls 620, 621 are connected to each other through first and second interlocking members 631, 632 secured to the upper and lower side walls 620, 621, respectively. The first and second interlocking members 631, 632 engage releasably each other in a hook-and-loop engaging manner. In this embodiment, the first and second interlocking members 631, 632 are made from Velco® fastening means. With the inclusion of the upper and lower side walls 620, 621 and the first and second interlocking members 631, 632, the height of the adhesive tape cutting device can be adjusted according to the actual thickness of the adhesive tape roll 5.

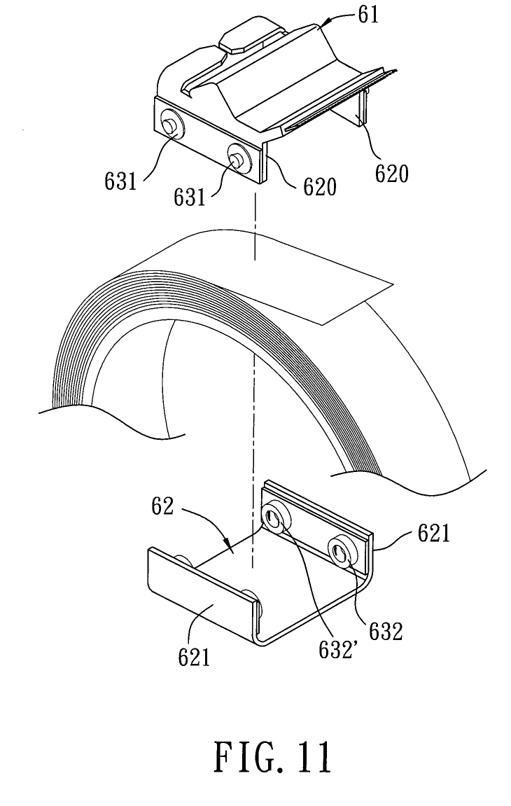

FIG. 11 illustrates the fourth preferred embodiment of the adhesive tape cutting device according to this invention. The fourth preferred embodiment differs from the third preferred embodiment in that the first and second interlocking members 633, 634 engage releasably each other in a tongue-and-groove engaging manner. In this embodiment, the first and second interlocking members 633, 634 are made from male and female fastening buttons.

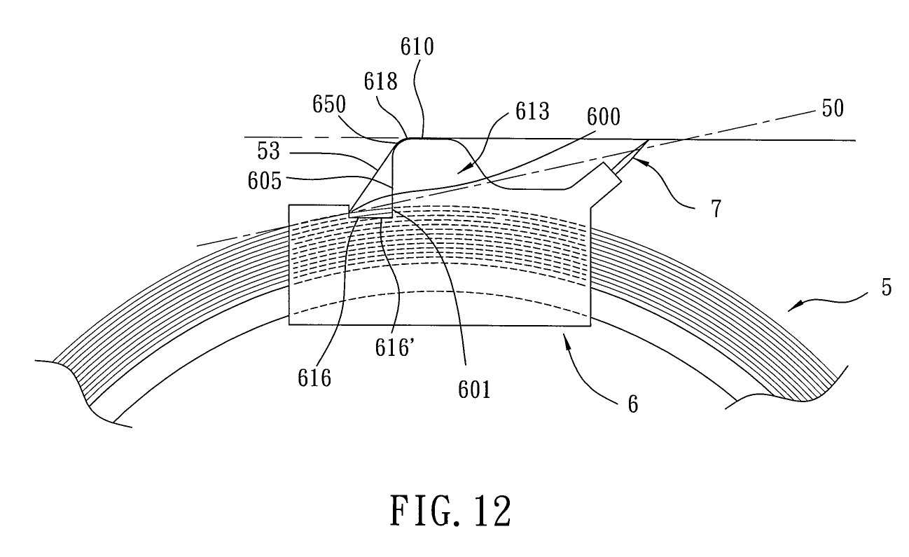

FIG. 12 illustrates the fifth preferred embodiment of the adhesive tape cutting device according to this invention. The fifth preferred embodiment differs from the previous embodiments in that the protruded portion 613 of the top wall 61 of the sleeve body 6 has a planar top surface 610 having a rear end 618 and a constant width, and an upright surface 605 transverse to the planar top surface 610 and extending inwardly and radially from the rear end 618 of the planar top surface 610 toward the front edge 601 of the slot-defining wall 616′. The planar top surface 610 and the upright surface 605 of the protruded portion 613 of the top wall 61 cooperatively define a corner 650 that is disposed at the other side of the tangent line 50.

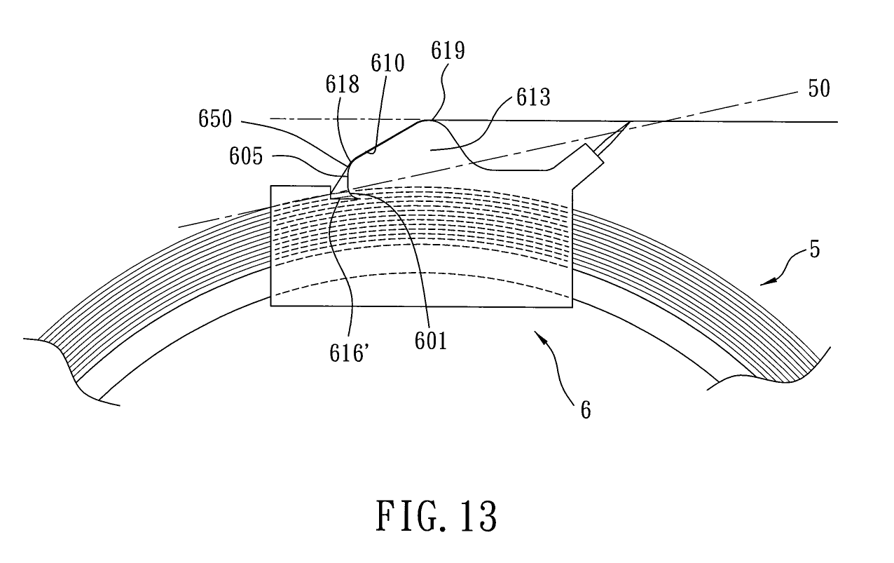

FIG. 13 illustrates the sixth preferred embodiment of the adhesive tape cutting device according to this invention. The sixth preferred embodiment differs from the fifth preferred embodiment in that the protruded portion 613 of the top wall 61 of the sleeve body 6 has a round top end 619, a planar rear surface 610 extending rearwardly and inclinedly from the round top end 619 and having a constant width, and an upright surface 605 extending inwardly and radially from a rear end 618 of the planar rear surface 610 toward the front edge 601 of the slot-defining wall 616′. The planar rear surface 610 and the upright surface 605 of the protruded portion 613 of the top wall 61 cooperatively define a corner 650 that is disposed at the other side of the tangent line 50.

By extending the protruded portion 613 of the top wall 61 of the sleeve body 6 of the adhesive tape cutting device of this invention through the tangent line 50, the aforesaid insufficient tension drawback associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An adhesive tape cutting device comprising:
a sleeve body adapted to be sleeved on an adhesive tape roll and defining a channel for extension of the adhesive tape roll there through, said sleeve body having a top wall defining a tape slot in spatial communication with said channel for extension of an unrolled end portion of an adhesive tape of the adhesive tape roll therethrough, said tape slot being defined by a slot-defining wall having opposite front and rear edges, said top wall having front and rear end portions and a protruded portion disposed between and protruding outwardly from said front end portion and said slot-defining wall, said rear end portion and said protruded portion being separated by said tape slot, said protruded portion extending outwardly and radially through a tangent line, which is adapted to be tangential relative to a center of the adhesive tape roll and which passes through said rear edge of said slot-defining wall, from one side of said tangent line to the other side of said tangent line that is distal from the adhesive tape roll compared to said one side of said tangent line; and
a cutting member mounted on said front end portion of said top wall of said sleeve body.

2. The adhesive tape cutting device as claimed in claim 1, wherein said protruded portion of said top wall of said sleeve body has a round top end and a planar rear surface extending rearwardly from said round top end toward said front edge of said slot-defining wall, said planar rear surface having a constant width.

3. The adhesive tape cutting device as claimed in claim 2, wherein said planar rear surface of said protruded portion of said top wall extends along a line that cooperates with said tangent line to define an angle ranging from 25 to 75 degrees.

4. The adhesive tape cutting device as claimed in claim 1, wherein said protruded portion of said top wall of said sleeve body has a planar top surface having a rear end, and an upright surface transverse to said planar top surface and extending inwardly and radially from said rear end of said planar top surface toward said front edge of said slot-defining wall, said planar top surface having a constant width.

5. The adhesive tape cutting device as claimed in claim 4, wherein said planar top surface and said upright surface of said protruded portion of said top wall cooperatively define a corner that is disposed at the other side of said tangent line.

6. The adhesive tape cutting device as claimed in claim 1, wherein said protruded portion of said top wall of said sleeve body has a round top end, a planar rear surface extending rearwardly from said round top end, and an upright surface extending inwardly and radially from said planar rear surface toward said front edge of said slot-defining wall, said planar rear surface having a constant width.

7. The adhesive tape cutting device as claimed in claim 6, wherein said planar rear surface and said upright surface of said protruded portion of said top wall cooperatively define a corner that is disposed at the other side of said tangent line.

8. The adhesive tape cutting device as claimed in claim 1, wherein said rear end portion of said top wall defines a tape slit extending therethrough to divide said rear end portion into two halves, said tape slit being in spatial communication with said tape slot for extension of the unrolled end portion of the adhesive tape of the adhesive tape roll therethrough and into and through said tape slot.

9. The adhesive tape cutting device as claimed in claim 8, wherein said tape slit extends in a transverse direction relative to said tape slot.

10. An adhesive tape cutting device comprising:
a sleeve body adapted to be sleeved on an adhesive tape roll and defining a channel for extension of the adhesive tape roll therethrough, said sleeve body having a top wall having front and rear end portions and a protruded portion and defining a tape slot that is in spatial communication with said channel and that separates said rear end portion and said protruded portion, said rear end portion of said top wall defining a tape slit to divide said rear end portion into two halves, said tape slit being in spatial communication with said tape slot for extension of an unrolled end portion of an adhesive tape of the adhesive tape roll therethrough and into and through said tape slot; and
a cutting member mounted on said front end portion of said top wall of said sleeve body.

11. The adhesive tape cutting device as claimed in claim 10, wherein said tape slit extends in a transverse direction relative to said tape slot.

12. The adhesive tape cutting device as claimed in claim 11, wherein said tape slit has a middle section and a rear section diverging from said middle section.

13. The adhesive tape cutting device as claimed in claim 12, wherein said tape slit further has a front section opposite to said rear section and diverging from said middle section.

14. The adhesive tape cutting device as claimed in claim 10, further comprising a cover, said sleeve body further having two opposite side walls extending downwardly and respectively from two opposite sides of said top wall, said cover being pivoted to said side walls and having a top wall for covering at least a portion of said top wall of said sleeve body.

15. The adhesive tape cutting device as claimed in claim 10, wherein said sleeve body further has two opposite upper side walls extending downwardly and respectively from two opposite sides of said top wall, a bottom wall opposite to said top wall, and two opposite lower side walls extending upwardly and respectively from two opposite sides of said bottom wall and connected detachably to said upper side walls so as to cooperate with said top and bottom walls and said upper side walls to define said channel.

16. The adhesive tape cutting device as claimed in claim 15, further comprising first and second interlocking members secured to said upper and lower side walls, respectively, said first and second interlocking members engaging releasably each other in a hook-and-loop engaging manner.

17. The adhesive tape cutting device as claimed in claim 15, further comprising first and second interlocking members secured to said upper and lower side walls, respectively, said first and second interlocking members engaging releasably each other in a tongue-and-groove engaging manner.
